(19) United States
(12) Patent Application Publication
(10) Pub. No.: US 2026/0299374 A1
(43) Pub. Date: Oct. 1, 2026

(54) CAMERA MODULE

(71) Applicant: Samsung Electro-Mechanics Co., Ltd., Suwon-si (KR)

(72) Inventor: Jae Hyung HAN, Suwon-si (KR)

(73) Assignee: Samsung Electro-Mechanics Co., Ltd., Suwon-si (KR)

(21) Appl. No.: 19/426,675

(22) Filed: Dec. 19, 2025

(30) Foreign Application Priority Data
Mar. 31, 2025 (KR) 10-2025-0040982

(51) Int. Cl. G03B 5/00

(52) U.S. Cl. CPC G03B 5/00; G03B 2205/0007; G03B 2205/0069

(57) ABSTRACT

A camera module including a housing; a reflective module including a guide member disposed in the housing and configured to be rotatable relative to the housing about a first axis extending in a first axial direction; a holder disposed on the guide member and configured to be rotatable relative to the guide member about a second axis extending in a second axial direction; and a reflective member disposed on the holder and configured to change a path of light incident in a third axial direction to the second axial direction; and a first driving unit configured to rotate the guide member and the holder and including a first magnet disposed on opposite side surfaces of the holder in the first axial direction; a first coil facing the first magnet in the first axial direction; and a pushing magnet facing the first magnet in the third axial direction.

### CROSS-REFERENCE TO RELATED APPLICATIONS

This application claims the benefit under 35 USC 119(a) of Korean Patent Application No. 10-2025-0040982 filed on Mar. 31, 2025, in the Korean Intellectual Property Office, the entire disclosure of which is incorporated herein by reference for all purposes.

### BACKGROUND

### 1. Field

The present disclosure relates to a camera module.

### 2. Description of Background

Recently, camera modules have been basically adopted in portable electronic devices, such as smartphones, tablet PCs, and laptops.

In order to miniaturize and slim down portable electronic devices, camera modules in which a reflective member is disposed in front of a lens module to bend an optical path have been widely used.

Many camera modules have an optical image stabilizing (OIS) function to prevent shaking during imaging in order to increase a resolution. Such an OIS function may be implemented by rotating the reflective member about two axes.

The reflective member is disposed in the camera module in a rotatable state to enable the OIS function, leading to a problem that the reflective member may tilt to one side when the camera module is turned off.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing; and a reflective module including a guide member disposed in the housing and configured to be rotatable relative to the housing about a first axis extending in a first axial direction; a holder disposed on the guide member and configured to be rotatable relative to the guide member about a second axis extending in a second axial direction; and a reflective member disposed on the holder and configured to change a path of light incident in a third axial direction to a second axial direction; and the camera module further includes a first driving unit configured to rotate the guide member and the holder and including a first magnet disposed on opposite side surfaces of the holder in the first axial direction; a first coil facing the first magnet in the first axial direction; and a pushing magnet facing the first magnet in the third axial direction.

Surfaces of the first magnet and the pushing magnet facing each other may have a same polarity.

The pushing magnet may be disposed in the housing.

The camera module may further include a first pulling magnet disposed on the guide member or in the housing; and a first pulling yoke facing the first pulling magnet in the third axial direction.

The camera module may further include a second pulling magnet disposed between the first magnet disposed on opposite side surfaces of the holder in the first axial direction; and a second pulling yoke facing the second pulling magnet in the third axial direction.

The second pulling magnet may be disposed on one of the holder and the guide member, and the second pulling yoke may be disposed on another one of the holder and the guide member.

An attractive force may act between the second pulling magnet and the second pulling yoke, and a repulsive force may act between the first magnet and the pushing magnet.

The attractive force acting between the second pulling magnet and the second pulling yoke may be greater than the repulsive force acting between the first magnet and the pushing magnet.

The camera module may further include a first stopper coupled to the housing to cover at least a portion of the reflective module, wherein the pushing magnet may be disposed on the first stopper.

The camera module may further include a plurality of first ball members disposed along the first axis; and a plurality of second ball members disposed along the second axis.

The plurality of first ball members may be disposed between the housing and the guide member, and the plurality of second ball members may be disposed between the guide member and the holder.

In another general aspect, camera module includes a housing; a guide member configured to rotate relative to the housing about a first axis extending in a first axial direction; a holder configured to rotate relative to the guide member about a second axis perpendicular to the first axis and extending in a second axial direction; a first magnet disposed on opposite side surfaces of the holder in the first axial direction; and a pushing magnet disposed to face the first magnet in a third axial direction perpendicular to each of the first axis and the second axis and configured to generate a repulsive force, wherein the pushing magnet includes a plurality of magnets symmetrically disposed with respect to the second axis.

The housing may include a lower surface, and one side surface and another side surface connected to the lower surface and facing each other in the first axial direction, and the pushing magnet may be disposed on the lower surface of the housing.

The pushing magnet may include a first pushing magnet adjacent to the one side surface of the housing and a second pushing magnet adjacent to the other side surface of the housing, and a torque generated by the first pushing magnet on the holder and a torque generated by the second pushing magnet on the holder may be balanced with respect to the second axis.

In a state in which no driving force is applied to rotate the holder, a gap between the holder and the one surface of the housing and a gap between the holder and the other surface of the housing may each be constant.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is an exploded perspective view of the camera module of FIG. 1.

FIG. 3 is a cutaway perspective view taken along the line III-III' in FIG. 1.

FIG. 4 is a cutaway perspective view taken along the line IV-IV' in FIG. 1.

FIG. 5 is an exploded perspective view illustrating a coupling relationship between a housing and a reflective module of the camera module of FIGS. 1 and 2.

FIG. 6 is a bottom perspective view of a guide member of the reflective module of the camera module of FIGS. 1 and 2.

FIG. 7 is an exploded perspective view illustrating a coupling relationship between the reflective module and a first driving unit of the camera module of FIGS. 1 and 2.

FIG. 8 is a diagram illustrating a rotational axis formed by a ball member and a pushing magnet of the camera module of FIGS. 1 and 2.

FIG. 9 is a diagram schematically illustrating the first driving unit, pulling magnets, pulling yokes, and the pushing magnet of the camera module of FIGS. 1 and 2.

FIG. 10 is a diagram schematically illustrating a state in which the reflective module of the camera module of FIGS. 1 and 2 is tilted to one side compared to FIG. 9, and a repulsive force acts on the tilted reflective module.

FIG. 11 is a cutaway perspective view of a camera module according to another embodiment of the present disclosure, which is a modification of FIG. 4.

FIG. 12 is a diagram schematically illustrating a first driving unit, pulling magnets, pulling yokes, and a pushing magnet of the camera module of FIG. 11.

FIG. 13 is a diagram schematically illustrating a state in which a reflective module of the camera module of FIG. 11 is tilted to one side compared to FIG. 12, and a repulsive force acts on the tilted reflective module.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as "above," "upper," "below," and "lower" may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being "above" or "upper" relative to another element will then be "below" or "lower" relative to the other element. Thus, the term "above" encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

The present disclosure relates to a camera module, and the camera module may be mounted in a portable electronic device, such as a mobile communication terminal, a smartphone, or a tablet PC.

A camera module according to an embodiment of the present disclosure may implement an optical image stabilization (OIS) function by rotating a reflective module about two rotational axes. To this end, the reflective module may be able to perform two types of rotational movements (rolling and pitching) when driven by a first driving unit.

The camera module according to an embodiment of the present disclosure may include a first magnet and a pushing magnet facing each other in a vertical direction (a Z-axis direction). Accordingly, even when the camera module is turned off, a phenomenon of the reflective module tilting to one side may be prevented. For example, even if the camera module is turned off and rotation (rolling) of the reflective module about a second axis (a Y-axis) occurs, the reflective module may be returned to the original position by a repulsive force generated between the pushing magnet and the first magnet.

Hereinafter, a detailed configuration and operation of the camera module according to an embodiment of the present disclosure will be described in detail with reference to the drawings.

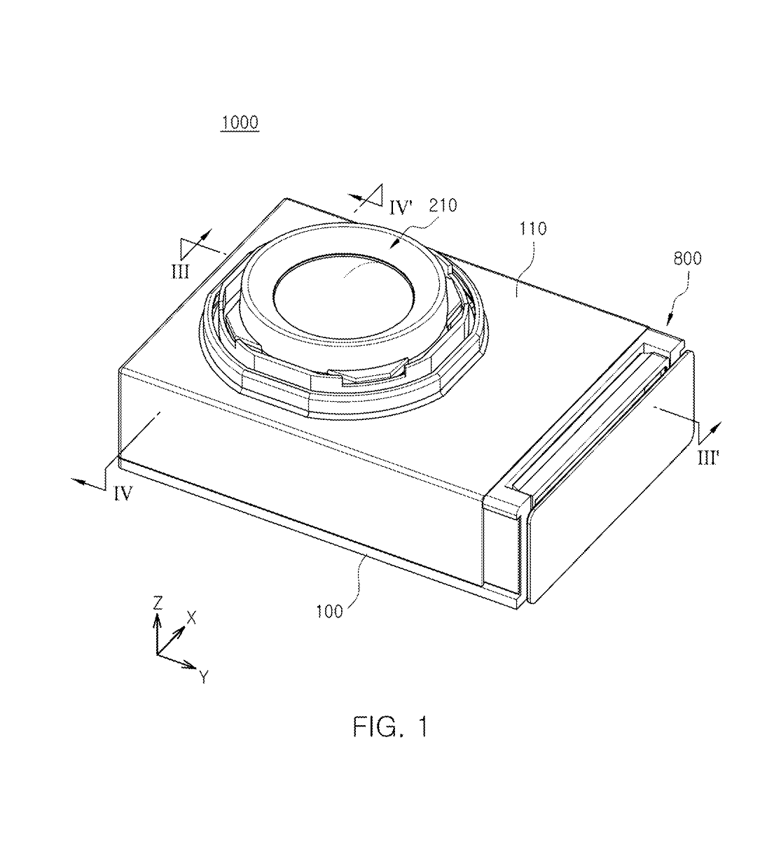

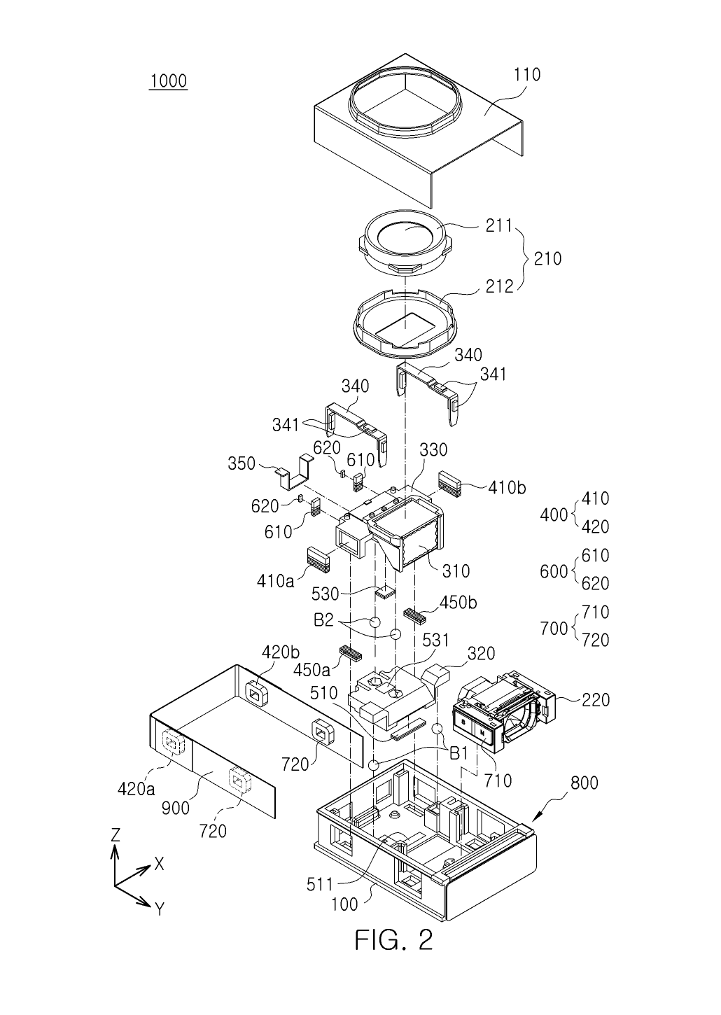

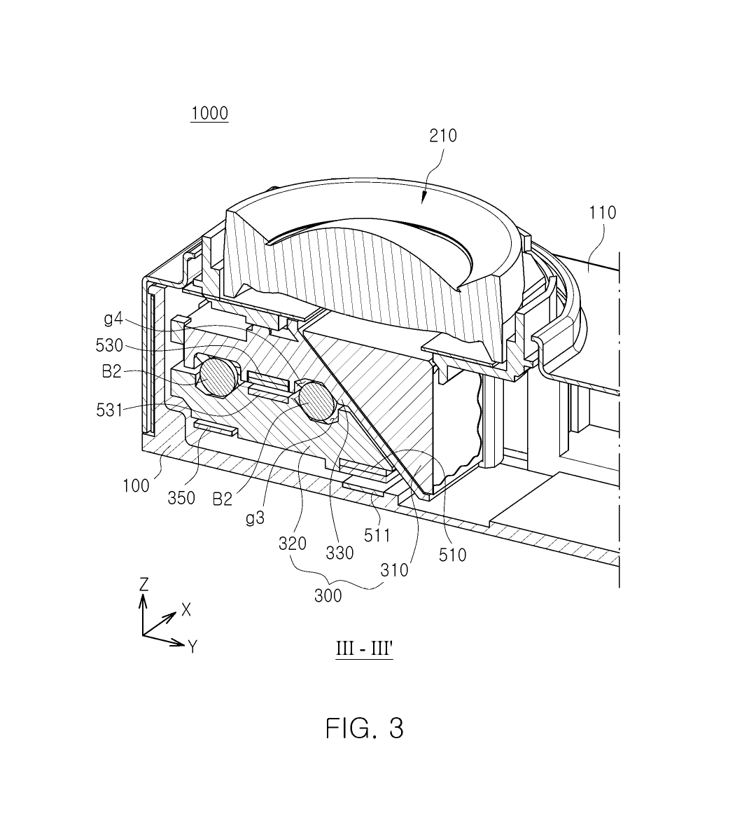

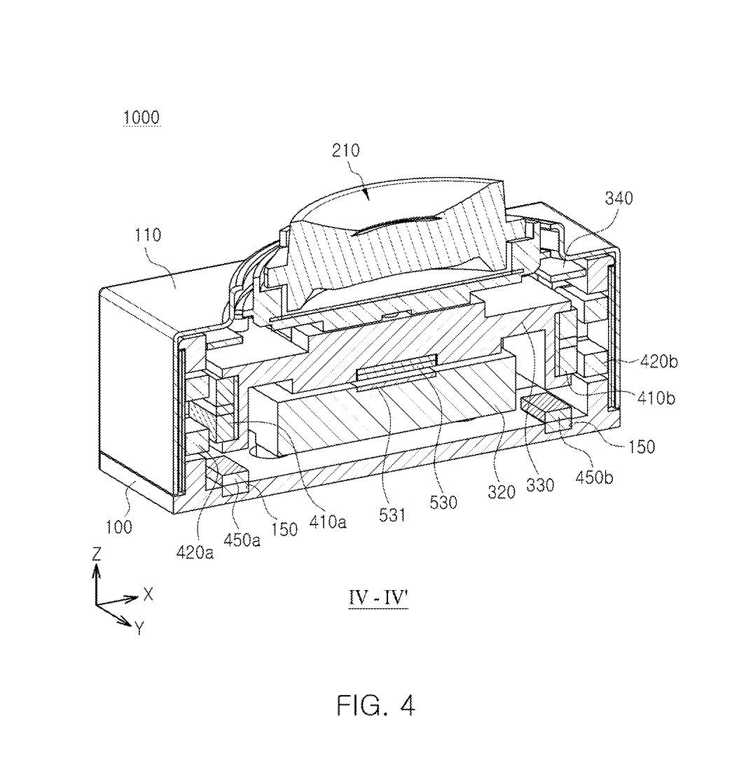

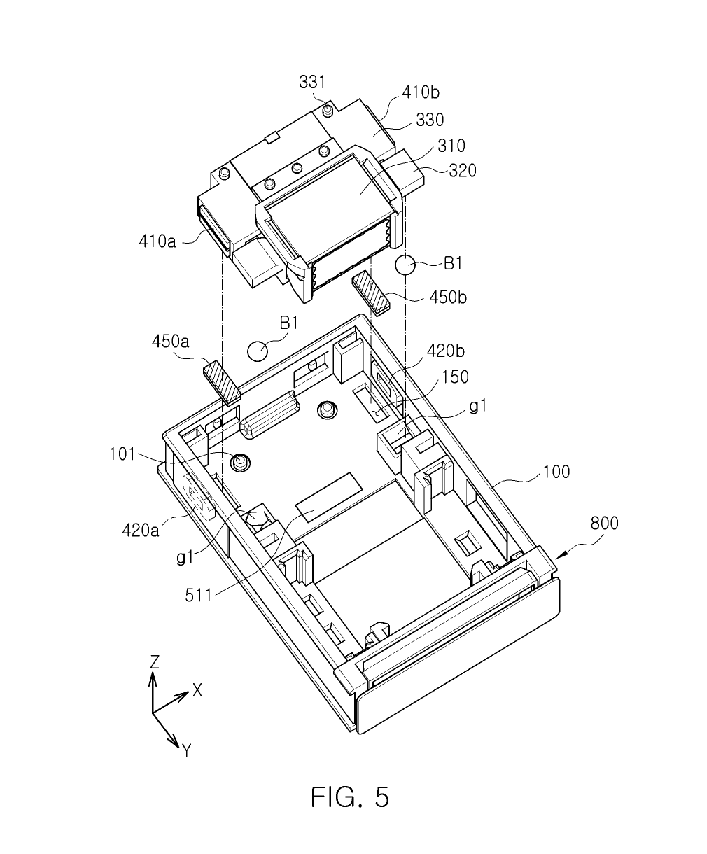

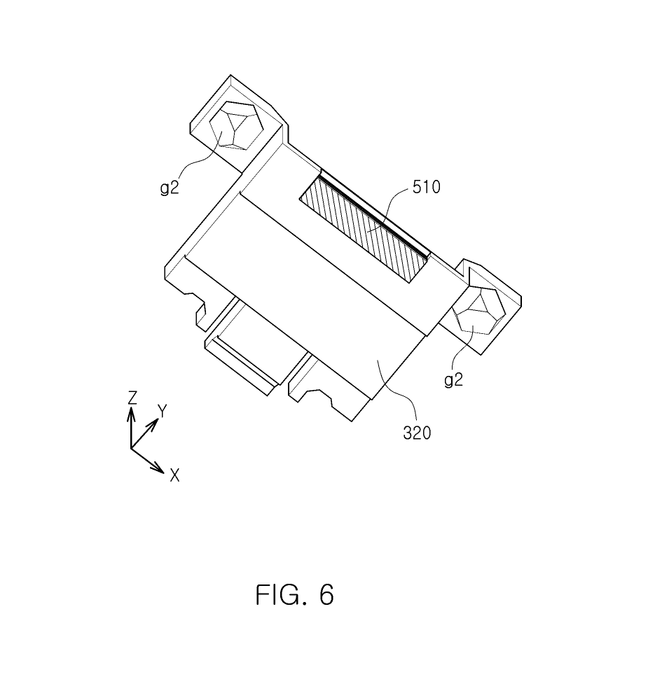

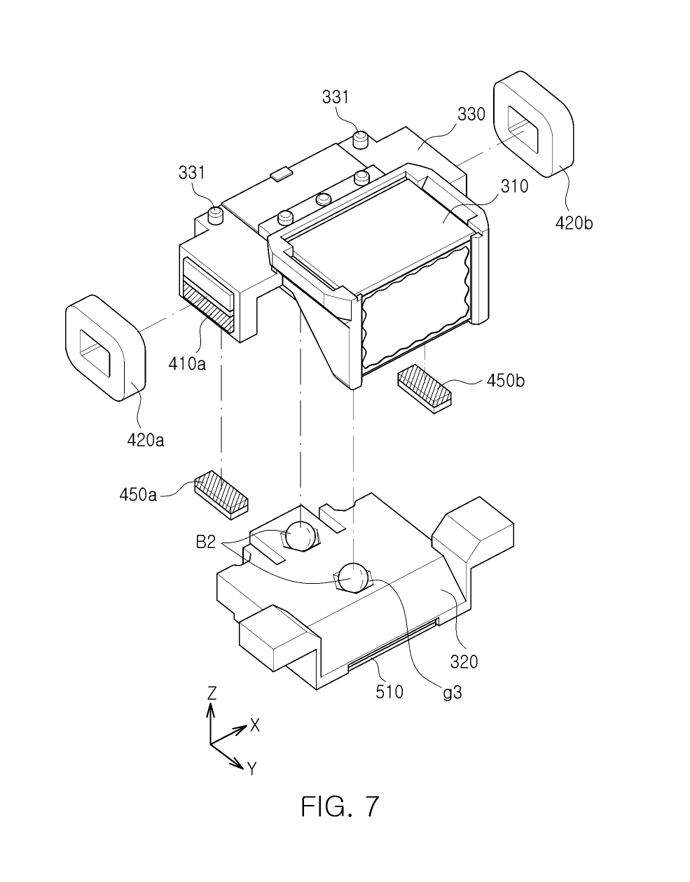

FIG. 1 is a perspective view of a camera module according to an embodiment of the present disclosure. FIG. 2 is an exploded perspective view of the camera module of FIG. 1. FIG. 3 is a cutaway perspective view taken along the line III-III' in FIG. 1. FIG. 4 is a cutaway perspective view taken along the line IV-IV' in FIG. 1. FIG. 5 is an exploded perspective view illustrating a coupling relationship between a housing and a reflective module of the camera module of FIGS. 1 and 2. FIG. 6 is a bottom perspective view of a guide member of the reflective module of the camera module of FIGS. 1 and 2. FIG. 7 is an exploded perspective view illustrating a coupling relationship between the reflective module and a first driving unit of the camera module of FIGS. 1 and 2.

Referring to FIGS. 1-7, a camera module 1000 according to an embodiment of the present disclosure may include a reflective module 300 and a housing 100.

The reflective module 300 may be disposed inside the housing 100 and may include a reflective member 310 having a reflective surface. In addition, the reflective module 300 may further include a guide member 320 disposed in the housing 100 and configured to be rotatable relative to the housing 100 about a first axis (the X-axis), and a holder 330 disposed on the guide member 320 and configured to be rotatable relative to the guide member 320 about a second axis (the Y-axis). The reflective member 310 is disposed on the holder 330 and may change a path of light incident in a third axis (the Z-axis) direction to the second axis (the Y-axis) direction. In this specification, the third axis (the Z-axis) may also be referred to as a first optical axis (the Z-axis), and the second axis (the Y-axis) may also be referred to as a second optical axis (the Y-axis).

The reflective module 300 may be configured to be rotatable about two different axes to perform an optical image stabilization (OIS) function. For example, the reflective module 300 may be configured to be rotatable about two axes (X-axis and Y-axis) perpendicular to each other within the housing 100.

In an embodiment, the camera module 1000 may further include a first lens module 210.

The first lens module 210 includes at least one lens having the first optical axis (the Z-axis). The first optical axis (the Z-axis) may extend in the vertical direction as shown in FIG. 2. The first optical axis (the Z-axis) may pass through the center of at the least one lens of the first lens module 210.

In an embodiment, the first lens module 210 includes a first lens barrel 211 and a first lens holder 212. The at least one lens is disposed in the first lens barrel 211, and the first lens barrel 211 may be coupled to the first lens holder 212. The first lens holder 212 may be coupled to the reflective module 300. Alternatively, the first lens module 210 may not include the first lens holder 212 and may include only the first lens barrel 211, and the first lens barrel 211 may be coupled to the reflective module 300.

The first lens module 210 may be disposed in front of the reflective module 300. Here, "front" may refer to a positive first optical axis (the Z-axis) direction (the +Z direction) with respect to the reflective module 300. For example, the first lens module 210 may be disposed above the reflective module 300 in the first optical axis (the Z-axis) direction.

The first lens module 210 may be coupled to the reflective module 300. For example, the first lens holder 212 of the first lens module 210 may be coupled to the holder 330 of the reflective module 300.

The first lens module 210 and the reflective module 300 may be disposed in the housing 100.

In an embodiment, the camera module 1000 may further include a second lens module 220. The reflective module 300 is disposed between the first lens module 210 and the second lens module 220. The second lens module 220 includes a plurality of lenses arranged along the second optical axis (the Y-axis). The second optical axis (the Y-axis) may pass through the center of the plurality of lenses of the second lens module 220.

The first optical axis (the Z-axis) of the first lens module 210 and the second optical axis (the Y-axis) of the second lens module 220 may be perpendicular to each other.

The first lens module 210 includes one or more lenses, and the second lens module 220 may include a plurality of lenses.

One or more lenses of the first lens module 210 may be circular when viewed in the first optical axis (the Z-axis) direction. At least one lens among the plurality of lenses of the second lens module 220 may be non-circular when viewed in the second optical axis (the Y-axis) direction. For example, the non-circular lens may have different diameters in two directions perpendicular to the second optical axis (the Y-axis) direction and perpendicular to each other. In an embodiment, the non-circular lens has a diameter in the first axis (the X-axis) direction, which is perpendicular to both the first optical axis (the Z-axis) direction and the second optical axis (the Y-axis) direction, that is greater than a diameter of the non-circular lens in the first optical axis (the Z-axis) direction.

The first lens module 210 and the reflective module 300 may be configured to rotate together to perform optical image stabilization (OIS). The second lens module 220 may be moved in the second optical axis (the Y-axis) direction to perform autofocusing (AF).

The camera module 1000 of the present embodiment may further include an image sensor module 800.

The image sensor module 800 may include a sensor housing, an image sensor, and a printed circuit board (PCB), and may further include an infrared (IR) cut filter.

The IR cut filter may be mounted in the sensor housing. The IR cut filter blocks light in an infrared region among light passing through the second lens module 220.

The PCB is coupled to the sensor housing, and an image sensor is disposed on the PCB.

Light passing through the second lens module 220 may be received by the image sensor module 800.

The camera module 1000 may further include a case 110. The case 110 is coupled to the housing 100 to cover an upper portion of the housing 100. The case 110 has an opening, and a first lens module 210 may be disposed in the opening.

The first lens module 210 may be disposed so that at least a portion thereof protrudes outside the housing 100 and the case 110.

The reflective module 300 of the present embodiment may include the reflective member 310, the holder 330, and the guide member 320.

The reflective member 310 has a reflective surface reflecting light passing through the first lens module 210. For example, the reflective member 310 may be a prism or a mirror.

When the reflective member 310 is a prism, the reflective member 310 may have any shape obtained by bisecting a rectangular solid (or a cube) in a diagonal direction. The prism may include an incident surface on which light is incident, a reflective surface reflecting light passing through the incident surface, and an exit surface from which light reflected from the reflective surface is emitted.

Referring to FIG. 3, the reflective member 310 may be mounted on the holder 330. The first lens module 210 may be disposed in front (in the +Z direction) of the reflective member 310. In an embodiment, the first lens module 210 may be mounted on the holder 330.

The holder 330 may be rotatably disposed on the guide member 320. Also, the guide member 320 may be rotatably disposed in the housing 100.

The guide member 320 may be rotated about the first axis (the X-axis) perpendicular to both the first optical axis (the Z-axis) and the second optical axis (the Y-axis) as a rotational axis. For example, the guide member 320 may be rotated relative to the housing 100 about the first axis (the X-axis) as a rotational axis. At this time, the first lens module 210 and the holder 330 may also be rotated together with the guide member 320.

The holder 330 may be rotated about the second optical axis (the Y-axis) perpendicular to the first axis (the X-axis) as a rotational axis. For example, the holder 330 may be rotated relative to the guide member 320 about the second optical axis (the Y-axis) as a rotational axis. At this time, the first lens module 210 may be rotated together with the holder 330. In this specification, the second optical axis (the Y-axis) may also be referred to as the second axis (the Y-axis).

Referring to FIGS. 5 and 7, the camera module 1000 according to the present embodiment may further include a first driving unit 400 for rotating the reflective module 300. The first driving unit 400 may include a first magnet 410 and a first coil 420. The first magnet 410 is shown in the drawings as two first magnets 410a and 410b spaced apart from each other in the first axis (the X-axis) direction, and the first coil 420 is shown in the drawings as two first coils 420a and 420b spaced apart from each other in the first axis (the X-axis) direction. In addition, the first driving unit 400 may further include a pushing magnet 450 for maintaining the reflective module 300 in a centered position even when power is not applied to the first driving unit 400 for rotating the reflective module 400. The pushing magnet 450 is shown in the drawings as two pushing magnets 450a and 450b spaced apart from each other in the first axis (the X-axis) direction.

The guide member 320 may be rotated relative to the housing 100 about the first axis (the X-axis) by the first driving unit 400. The holder 330 and the first lens module 210 may be disposed on the guide member 320 so that the holder 330 and the first lens module 210 may also be rotated together with the guide member 320.

The first magnet 410 may be mounted on the holder 330. For example, the first magnet 410 may be mounted on a side surface of the holder 330. The side surface of the holder 330 may refer to one side surface of the holder 330 facing the housing 100 in the first axis (the X-axis) direction. In addition, the first magnet 410 may be include two first magnets 410a and 410b respectively mounted on opposite side surfaces of the holder 300 in the first axis (the X-axis) direction.

The first magnet 410 may be magnetized so that one surface (for example, the surface facing the first coil 420) has both an N pole and an S pole. In an embodiment, the one surface of the first magnet 410 facing the first coil 420 may be provided with an N pole, a neutral region, and an S pole sequentially arranged n the first optical axis (the Z-axis) direction.

The first coil 420 may be disposed to face the first magnet 410. In an embodiment, the first coil 420 may be disposed to face the first magnet 410 in the first axis (the X-axis) direction.

Referring to FIGS. 2 and 5, the first coil 420 may be disposed on a substrate 900, and the substrate 900 may be mounted on the housing 100 so that the first magnet 410 and the first coil 420 face each other in the first axis (the X-axis) direction.

A through-hole may be formed in the housing 100 and penetrate through the housing 100 in the first axis (the X-axis) direction, and the first coil 420 may be disposed in the through-hole to directly face the first magnet 410.

When the OIS function is being performed, the first magnet 410 may be a movable member mounted on the holder 330 and rotating, and the first coil 420 may be a fixed member fixed to the substrate 900.

When power is applied to the first driving unit 400, the first driving unit 400 may generate a driving force to rotate the holder 330 and the guide member 320 about the first axis (the X-axis) as a rotational axis. For example, the first driving unit 400 may generate the driving force in the first optical axis (the Z-axis) direction.

The first magnet 410 may include a plurality of magnets. In an embodiment, the first magnet 410 may include two magnets 410a and 410b spaced apart from each other. The two magnets 410a and 410b of the first magnet 410 may be spaced apart from each other in the first axis (the X-axis) direction.

One of the two magnets 410a and 410b of the first magnet 410 may be disposed on one side surface of the holder 330, and the other one of the two magnets 410a and 410b may be disposed on another side surface of the holder 330. The one side surface of the holder 330 and the other side surface of the holder 330 may be spaced apart from each other in the first axis (the X-axis) direction.

The first coil 420 may include a plurality of coils. In an embodiment, the first coil 420 may include two coils 420a and 420b spaced apart from each other. The two coils 420a and 420b of the first coil 420 may be spaced apart from each other in the first axis (the X-axis) direction.

In an embodiment, a pair of the magnet 410a and the coil 420a may be disposed on one side of the reflective module 300, and another pair of the magnet 410b and the coil 420b may be disposed on the other side of the reflective module 300.

When the guide member 320 and the holder 330 are rotated about the first axis (the X-axis) as a rotational axis, a direction of a driving force generated by the one pair of the magnet 410a and the coil 420a and a direction of a driving force generated by the other pair of the magnet 410b and the coil 420b may be the same.

For example, when the direction of the driving force generated by the one pair of the magnet 410a and the coil 420a is in a positive first optical axis (the Z-axis) direction (the +Z direction) and the direction of the driving force generated by the other pair of the magnet 410b and the coil 420b is also in the positive first optical axis (the Z-axis) direction (the +Z direction), the guide member 320 and the holder 330 may be rotated together in one direction about the first axis (the X-axis).

In addition, when the direction of the driving force generated by the one pair of the magnet 410a and the coil 410a is in a negative first optical axis (the Z-axis) direction (the -Z direction) and the direction of the driving force generated by the other pair of the magnet 410b and the coil 420b is also in the negative first optical axis (the Z-axis) direction (the -Z direction), the guide member 320 and the holder 330 may be rotated together in an opposite direction about the first axis (the X-axis) relative to the one direction mentioned above.

Referring to FIGS. 2 and 5, a first ball member B1 may be disposed between the guide member 320 and the housing 100. The first ball member B1 may be disposed between the guide member 320 and the housing 100 to form a rotational axis of the guide member 320.

The first ball member B1 includes a plurality of balls spaced apart from each other in the first axis (the X-axis) direction. A virtual line connecting the plurality of balls of the first ball member B1 in the first axis (the X-axis) direction may be spaced apart from the first magnet 410 in the second optical axis (the Y-axis) direction.

In an embodiment, the first magnet 410 and the first coil 420 may be spaced apart from the first ball member B1 in the second optical axis (the Y-axis) direction. When a driving force is generated in the first optical axis (the Z-axis) direction by the first magnet 410 and the first coil 420, the holder 330 may be rotated about a rotational axis formed by the first ball member B1. Since the holder 330 is disposed on the guide member 320, the holder 330 and the guide member 320 may be rotated together about the first axis (the X-axis) by the first driving unit 400.

An attractive force may act between the guide member 320 and the housing 100. Referring to FIG. 3, a first pulling magnet 510 may be disposed on one of the guide member 320 and the housing 100, and a first pulling yoke 511 may be disposed on the other one of the guide member 320 and the housing 100.

In an embodiment, the first pulling magnet 510 may be disposed on a lower surface of the guide member 320, and the first pulling yoke 511 may be disposed on a bottom surface of the housing 100.

The first pulling magnet 510 and the first pulling yoke 511 may face each other in the first optical axis (the Z-axis) direction.

An attractive force may act between the first pulling magnet 510 and the first pulling yoke 511. For example, the first pulling yoke 511 may be made of a magnetic material. An attractive force may act between the first pulling magnet 510 and the first pulling yoke 511 in the first optical axis (the Z-axis) direction.

The first ball member B1 may be maintained in contact with each of the guide member 320 and the housing 100 by the attractive force acting between the first pulling magnet 510 and the first pulling yoke 511.

Referring to FIGS. 5 and 6, a first guide recess g1 and a second guide recess g2 may be provided in surfaces of the guide member 320 and the housing 100 facing each other (for example, surfaces facing each other in the first optical axis (the Z-axis) direction). For example, the first guide recess g1 may be provided in the housing 100, and the second guide recess g2 may be provided in the guide member 320. The first guide recess g1 and the second guide recess g2 may face each other in the first optical axis (the Z-axis) direction.

The first guide recess g1 may include a plurality of recesses spaced apart from each other in the first axis (the X-axis) direction, and the second guide recess g2 may include a plurality of recesses spaced apart from each other in the first axis (the X-axis) direction.

The first ball member B1 may be disposed between the first guide recess g1 and the second guide recess g2 to form a rotational axis of the guide member 320.

One of the plurality of recesses of the first guide recess g1 may be in three-point contact with the first ball member B1, and another of the plurality of recesses of the first guide recess g1 may be in two-point contact with the first ball member B1. For example, referring to FIG. 5, a recess located on the left side among the plurality of recesses of the first guide recess g1 may be in three-point contact with the first ball member B1, and a recess located on the right side among the plurality of recesses of the first guide recess g1 may be in two-point contact with the first ball member B1.

Also, the plurality of recesses of the second guide recess g2 may each be in three-point contact with the first ball member B1. It is also possible to switch the shape of the first guide recess g1 and the shape of the second guide recess g2 with each other so that the first guide recess g1 has the shape of the second guide recess g2 in FIG. 6, and the second guide recess g2 has the shape of the first guide recess in FIG. 5.

The first driving unit 400 may rotate the holder 330 about the second axis (the Y-axis). Since the first lens module 210 is disposed on the holder 330, the first lens module 210 may also rotate together with the holder 330 about the second axis (the Y-axis).

When power is applied to the first driving unit 400, the first driving unit 400 may generate a driving force to rotate the holder 330 about the second axis (the Y-axis) as a rotational axis. For example, the first driving unit 400 may generate a driving force in the third axis (the Z-axis) direction.

In an embodiment, when the holder 330 is rotated about the second axis (the Y-axis) as a rotational axis, a direction of a driving force generated by a pair of a magnet 410a and a coil 420a and a direction of a driving force generated by another pair of a magnet 410b and a coil 420b may be opposite to each other.

For example, when the driving force generated by the one pair of the magnet 410a and the coil 420a is in the +Z direction and the driving force generated by the other pair of the magnet 410b and the coil 420b is in the -Z direction, the holder 330 may be rotated in one direction about the second axis (the Y-axis).

In addition, when the driving force generated by the one pair of the magnet 410a and the coil 420a is in the -Z direction and the driving force generated by the other pair of the magnet 410b and the coil 420b is in the +Z direction, the holder 330 may be rotated in an opposite direction about the second axis (the Y-axis) relative to the one direction mentioned above.

Referring to FIGS. 3 and 7, a second ball member B2 may be disposed between the holder 330 and the guide member 320. The second ball member B2 may be disposed between the holder 330 and the guide member 320 to form a rotational axis of the holder 330.

The second ball member B2 includes a plurality of balls spaced apart from each other in the second axis (the Y-axis) direction. A virtual line connecting the plurality of balls of the second ball member B2 in the second axis (the Y-axis) direction may be spaced apart from the first magnet 410 in the first axis (the X-axis) direction.

In an embodiment, the first magnet 410 and the first coil 420 may be spaced apart from the second ball member B2 in the first axis (the X-axis) direction. When driving forces are generated in opposite directions in the third axis (the Z-axis) direction by the first magnet 410 and the first coil 420 as discussed above, the holder 330 may be rotated about the rotational axis formed by the second ball member B2.

A third guide recess g3 and a fourth guide recess g4 may be provided in surfaces of the holder 330 and the guide member 320 facing each other (for example, surfaces facing each other in the first optical axis (the Z-axis) direction). For example, the third guide recess g3 may be provided in the guide member 320, and the fourth guide recess g4 may be provided in the holder 330. The third guide recess g3 and the fourth guide recess g4 may face each other in the first optical axis (the Z-axis) direction.

The third guide recess g3 includes a plurality of recesses spaced apart from each other in the second optical axis (the Y-axis) direction, and the fourth guide recess g4 includes a plurality of recesses spaced apart from each other in the second optical axis (the Y-axis) direction.

The second ball member B2 may be disposed between the third guide recess g3 and the fourth guide recess g4 to form a rotational axis of the holder 330.

One of the plurality of recesses of the fourth guide recess g4 may be in three-point contact with the second ball member B2, and another one of the plurality of recesses of the fourth guide recess g4 may be in two-point contact with the second ball member B2. In addition, the plurality of recesses of the third guide recess g3 may each be in three-point contact with the second ball member B2. It is also possible to switch the shape of the third guide recess g3 and the shape of the fourth guide recess g4 with each other so that the third guide recess g3 has the shape of the second guide recess g4 in FIG. 3, and the fourth guide recess g4 has the shape of the third guide recess in FIGS. 3 and 7.

An attractive force may act between the holder 330 and the guide member 320. Referring to FIGS. 3 and 4, a second pulling magnet 530 may be disposed on one of the holder 330 and the guide member 320, and a second pulling yoke 531 may be disposed on the other one of the holder 330 and the guide member 320.

In an embodiment, the second pulling magnet 530 may be disposed on the holder 330, and the second pulling yoke 531 may be disposed on the guide member 320.

The second pulling magnet 530 and the second pulling yoke 531 may face each other in the third axis (the Z-axis) direction.

In an embodiment, the second pulling magnet 530 may be disposed on a lower surface of the holder 330, and the second pulling yoke 531 may be disposed on an upper surface of the guide member 320.

The second pulling magnet 530 may be disposed between the plurality of recesses of the fourth guide recess g4. Also, the second pulling yoke 531 may be disposed between the plurality of recesses of the third guide recess g3.

The camera module 1000 according to an embodiment of the present disclosure may include a pushing magnet 450 as a component to prevent the reflective module 300 from rotating to one side about the second axis (the Y-axis) when power is not applied to the driving unit 400. The pushing magnet 450 may include a plurality of pushing magnets 450a and 450b disposed symmetrically with respect to the second axis (the Y-axis).

Referring to FIGS. 4, 5, 7, and 8, the pushing magnet 450 of the present embodiment may be disposed to face the first magnet 410 in the third axis (the Z-axis) direction. The pushing magnet 450 may be disposed in the housing 100. For example, the pushing magnet 450 may be disposed on a lower surface of the housing 100. The lower surface of the housing 100 may refer to a bottom surface of an inner surface of the housing 100. The pushing magnet 450 may be disposed in a groove 150 in the bottom surface of the inner surface of the housing 100 as shown in FIGS. 4 and 5. When the pushing magnet 450 is disposed in the housing 100, the holder 330 may be maintained at an original position relative to the housing 1000 by the pushing magnet 450. Here, the original position may refer to a state not inclined to one side around the second axis (Y axis) as a rotational axis.

However, the present disclosure is not limited thereto, and the pushing magnet 450 may be disposed on the guide member 320. When the pushing magnet 450 is disposed on the guide member 320, an accommodation portion for accommodating the pushing magnet 450 may be added to the guide member 320, and the holder 330 may be maintained at an original position relative to the guide member 320 by the pushing magnet 450.

A repulsive force may be generated between the pushing magnet 450 and the first magnet 410. The magnitude of the repulsive force generated between the pushing magnet 450 and the first magnet 410 may be smaller than the magnitude of the attractive force generated between the second pulling magnet 530 and the second pulling yoke 531. Therefore, the second ball member B2 may be maintained in contact with each of the holder 330 and the guide member 320 by the attractive force generated between the second pulling magnet 530 and the second pulling yoke 531.

In an embodiment, the surfaces of the first magnet 410 and the pushing magnet 450 facing each other may have the same polarity. The surface of the pushing magnet 450 facing the first magnet 410 may be configured to have one polarity. For example, one surface of the pushing magnet 450 may have a first polarity, and the other surface (for example, the opposite surface of the one surface) may have a second polarity. The first polarity may be a N pole or an S pole, and the second polarity may be a polarity opposite to the first polarity.

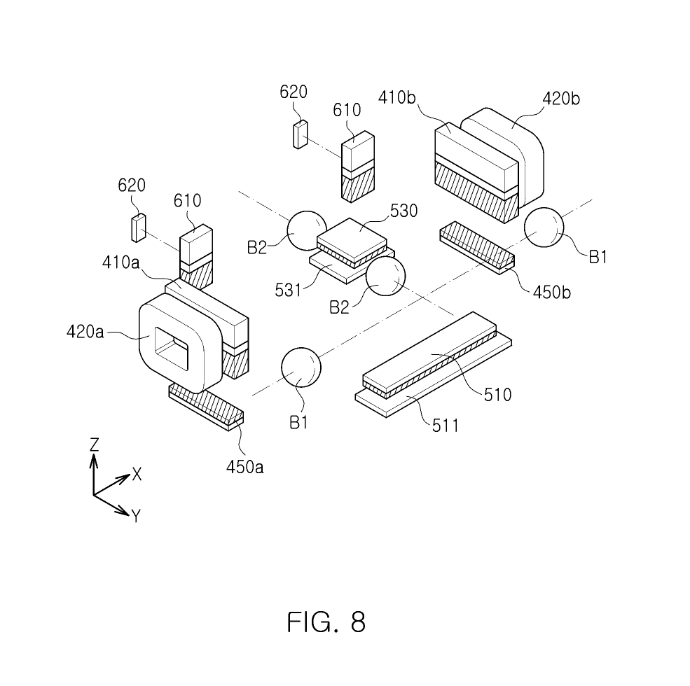

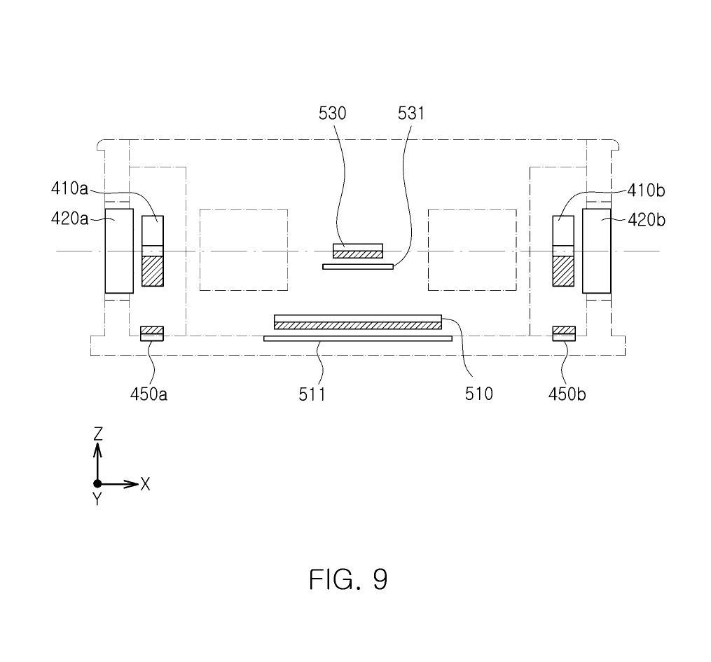

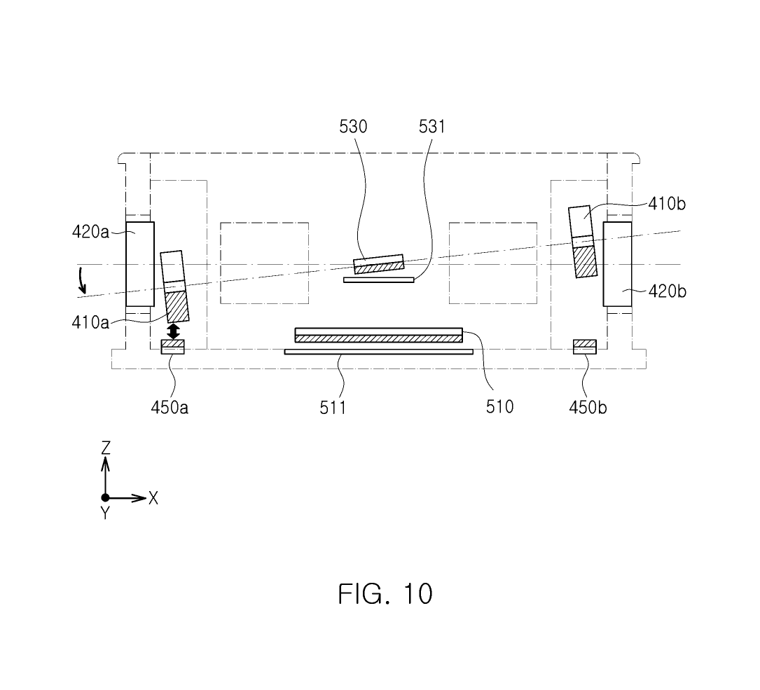

FIG. 8 is a diagram illustrating a rotational axis formed by a ball member and a pushing magnet of the camera module of FIGS. 1 and 2. FIG. 9 is a diagram schematically illustrating the first driving unit, pulling magnets, pulling yokes, and the pushing magnet of the camera module of FIGS. 1 and 2. FIG. 10 is a diagram schematically illustrating a state in which the reflective module of the camera module of FIGS. 1 and 2 is tilted to one side compared to FIG,9, and a repulsive force acts on the tilted reflective module.

The housing 100 may include one side surface and another side surface connected to a lower surface of the housing 100 and facing each other in the first axial direction, and the pushing magnet 450 of the present embodiment may include a first pushing magnet 450a adjacent to the one side surface of the housing 100 and a second pushing magnet 450b adjacent to the other side surface of the housing 100. A torque generated by the first pushing magnet 450a on the holder 330 about the second axis (the Y-axis) and a torque generated by the second pushing magnet 450b on the holder 330 about the second axis (the Y-axis) may be balanced with each other.

Referring to FIGS. 8 to 10, when a distance between the first magnet 410a and the first pushing magnet 450a becomes relatively short due to rotation of the holder 330 about the second axis (the Y-axis) as illustrated in FIG. 10, a repulsive force generated between the first magnet 410a and the first pushing magnet 450a becomes stronger than a repulsive force generated between the second magnet 410b and the second pushing magnet 450b, so that the holder 330 may return to the original position even when power is not applied to the first driving unit 400 for rotating the reflective module 300. Here, the original position may refer to a state in which the holder 330 is not rotated, for example, a state in which the second pulling magnet 530 and the second pulling yoke 531 are parallel as illustrated in FIG. 9.

Therefore, in the camera module 1000 of the present embodiment, when a driving force for rotating the holder 330 is not applied, a gap between the holder 330 and the one side surface of the housing 100 may be maintained constant by the pushing magnet 450. In addition, the gap between the holder 330 and the other side surface of the housing 100 may also be maintained constant by the pushing magnet 450.

The camera module 1000 according to an embodiment of the present disclosure may reduce power consumption for positioning the holder 330 by mechanically implementing a centering structure of the holder 330. Therefore, when the OIS function is not required (for example, when power is not applied to the driving unit 400 for rotating the reflective module 300), the position of the holder 330 may be adjusted without consuming power.

In an embodiment, the camera module 1000 may detect the positions of the guide member 320 and the holder 330. To this end, a position sensing unit 600 is provided. The position sensing unit 600 may include a sensing magnet 610 and a first position sensor 620.

Referring to FIGS. 2 and 8, the sensing magnet 610 may be disposed on the holder 330. For example, the sensing magnet 610 may be disposed on a rear surface of the holder 300. One surface of the sensing magnet 610 (for example, the surface facing the first position sensor 620) may be magnetized to have a N pole, a neutral region, and an S pole sequentially arranged in the third axis (the Z-axis) direction.

The first position sensor 620 may be disposed at a position facing the sensing magnet 610 (for example, a position facing the sensing magnet 610 in the second axis (the Y-axis) direction). The first position sensor 620 may be disposed on the substrate 900.

In the original position, the neutral region of the sensing magnet 610 may face the first position sensor 620. Here, the original position may refer to a state in which the holder 330 and the guide member 320 are not rotated, for example, a state in which the second pulling magnet 530 and the second pulling yoke 531 are parallel to each other.

When the guide member 320 and the holder 330 are rotated about the first axis (the X-axis) as a rotational axis, a distance between the sensing magnet 610 and the first position sensor 620 in the second axis (the Y-axis) direction may change, and the position of the guide member 320 may be detected based on this change. The first position sensor 620 may be a Hall sensor.

When the holder 330 is rotated about the second axis (the Y-axis) as a rotational axis, the area of a polarity of the one surface of the sensing magnet 610 facing the first position sensor 620 changes, so that the position of the holder 330 may be detected based on this change.

The sensing magnet 610 may include a plurality of magnets spaced apart from each other in the first axis (the X-axis) direction, and the first position sensor 620 may include a plurality of Hall sensors spaced apart from each other in the first axis (the X-axis) direction. When the sensing magnet 610 and the first position sensor 620 are provided in plural, the accuracy of position sensing may be improved.

A virtual line connecting a plurality of balls of the second ball member B2 may be positioned between the plurality of sensing magnets 610. Distances from a virtual line connecting the plurality of balls of the second ball member B2 to each sensing magnet 610 may be the same.

One surface of each sensing magnet 610 (for example, the surface facing the first position sensor 620) may have the S pole, a neutral region, and the N pole sequentially arranged in the +Y direction. That is, the polarity magnetization forms of the plurality of sensing magnets 610 may be the same.

The position sensing unit 600 may further include a controller (not shown). The controller may be a driver IC. In an embodiment, the driver IC and the first position sensor 620 may be provided in the form of a single chip.

The position sensing unit 600 may apply power in an appropriate direction with an appropriate magnitude to the plurality of first coils 420 by feedback controlling signal values output from the plurality of first position sensors 620 so that the holder 330 and the guide member 320 may be disposed at target positions.

In the present embodiment, the position sensing unit 600 is described as including a plurality of sensing magnets 610, but it is also possible to configure the position sensing unit 600 to not include a plurality of sensing magnets 610, but only include a plurality of first position sensors 620. In this case, the plurality of first position sensors 620 may be disposed to face the plurality of first magnets 410 and may be disposed on the inside or outside of the plurality of first coils 420.

Referring to FIGS. 2 and 4, the camera module 1000 may include a first stopper 340. The first stopper 340 may be coupled to the housing 100 to cover at least a portion of the reflective module 300. For example, the first stopper 340 may cover at least a portion of the upper surface of the holder 330. The first stopper 340 and the holder 330 may be spaced apart from each other in the third axis (the Z-axis) direction. In addition, the first stopper 340 and the holder 330 may be spaced apart from each other in the second axis (the Y-axis) direction.

Since the first stopper 340 is spaced apart from the reflective module 300, the reflective module 300 may be prevented from escaping from the housing 100 due to an external impact, etc., while not interfering with the rotation of the reflective module 300.

Am elastic buffer member 341 may be coupled to the first stopper 340. The buffer member 341 may be disposed on either one or both of one surface and another surface of the first stopper 340. The one surface of the first stopper 340 may be a surface facing the case 110 in the third axis (the Z-axis) direction, and the other surface of the first stopper 340 may be a surface facing the holder 330 in the third axis (the Z-axis) direction.

In addition, the buffer member 341 may also be disposed on a side surface of the first stopper 340. The side surface of the first stopper 340 may be a surface facing the holder 330 in the second axis (the Y-axis) direction.

A second stopper 350 may be coupled to the guide member 320 or the holder 330. In an embodiment, the second stopper 350 may be fixed to the holder 330, and a portion of the second stopper 350 may extend toward the guide member 320. A coupling portion, to which the second stopper 350 is coupled, may be disposed on the holder 330. The coupling portion may have a shape of a recess or a hole.

An accommodation portion may be disposed on the guide member 320, in which a portion of the second stopper 350 is accommodated. The accommodation portion may have a shape of a recess or a hole.

The second stopper 350 may be fixed to the coupling portion of the holder 330, and a portion of the second stopper 350 may extend toward the guide member 320 to be accommodated in the accommodation portion of the guide member 320.

A portion of the second stopper 350 may be disposed to be spaced apart from the accommodation portion. The end of the portion of the second stopper 350 may be bent and extend within the accommodation portion. The portion of the second stopper 350 and the accommodation portion of the guide member 320 may have shapes corresponding to each other. In an embodiment, the end of the portion of the second stopper 350 and the accommodation portion may face each other in the first optical axis (the Z-axis) direction.

Therefore, the second stopper 350 may prevent the holder 330 from escaping from the guide member 320 due to an external impact, etc., without interfering with the rotation of the holder 330.

Referring to FIG. 5, a buffer member 101 may be disposed on at least one of the surfaces of the guide member 320 and the housing 100 facing each other.

In an embodiment, the elastic buffer member 101 may be disposed on an inner bottom surface of the housing 100. The inner bottom surface of the housing 100 may be a surface facing the guide member 320 in the third axis (the Z-axis) direction. As another example, the buffer member 101 may be disposed on a lower surface of the guide member 320 (a surface facing the inner bottom surface of the housing 100 in the third axis (the Z-axis) direction).

Therefore, when the guide member 320 rotates based on the first axis (the X-axis), a rotation range may be limited by the buffer member 101, so when the guide member 320 and the housing 100 collide with each other, the amount of impact and noise may be reduced.

Referring to FIGS. 2 and 5, a buffer member 331 may be disposed on at least one of the surfaces of the holder 330 and the first stopper 340 facing each other.

In an embodiment, the buffer member 331 may be disposed on an upper surface of the holder 330 (a surface facing a lower surface of the first stopper 340 in the third axis (the Z-axis) direction). The buffer member 331 may be made of an elastic material.

Therefore, when the holder 330 rotates about the second axis (the Y-axis), the rotation range may be limited by the buffer member 331, so when the holder 330 and the first stopper 340 collide with each other, the amount of impact and noise may be reduced.

Referring to FIG. 2, the camera module 1000 of the present embodiment may have a second lens module 220 disposed between the reflective module 300 and the image sensor module 800. The second lens module 220 may be moved in the second axis (the Y-axis) direction for autofocusing.

In addition, the camera module 1000 of the present embodiment may include a second driving unit 700 to move the second lens module 220 in the second axis (the Y-axis) direction. The second driving unit 700 may include a second magnet 710 and a second coil 720. The second magnet 710 and the second coil 720 may be disposed to face each other in the first axis (the X-axis) direction.

The second magnet 710 may be mounted on the second lens module 220. For example, the second magnet 710 may be disposed on a side surface of the second lens module 220.

In an embodiment, the second magnet 710 may include two magnets, and one magnet may be mounted on each of one side surface and another side surface of the second lens module 220. The one side surface and the other side surface of the second lens module 220 may be spaced apart from each other in the first axis (the X-axis) direction.

The second magnet 710 may be magnetized so that one surface (for example, the surface facing the second coil 720) has both an N pole and an S pole. For example, one surface of the second magnet 710 facing the second coil 720 may be provided with the N pole, a neutral region, and the S pole sequentially arranged in the second axis (the Y-axis) direction.

The second coil 720 may be disposed on the substrate 900, and the substrate 900 may be mounted on the housing 100 so that the second magnet 710 and the second coil 720 face each other in the first axis (the X-axis) direction. In an embodiment, the second coil 720 may include two coils spaced apart from each other in the first axis (the X-axis) direction.

The housing 100 may include a through-hole penetrating through the housing 100, and the second coil 720 disposed on the substrate 900 may directly face the second magnet 710 through the through-hole.

During autofocusing, the second magnet 710 is a moving member mounted on the second lens module 220 and moving in the second optical axis (the Y-axis) direction together with the second lens module 220, and the second coil 720 may be a fixed member fixed to the substrate 900. When power is applied to the second coil 720, the second lens module 220 may be moved in the second axis (the Y-axis) direction by an electromagnetic force generated between the second magnet 710 and the second coil 720.

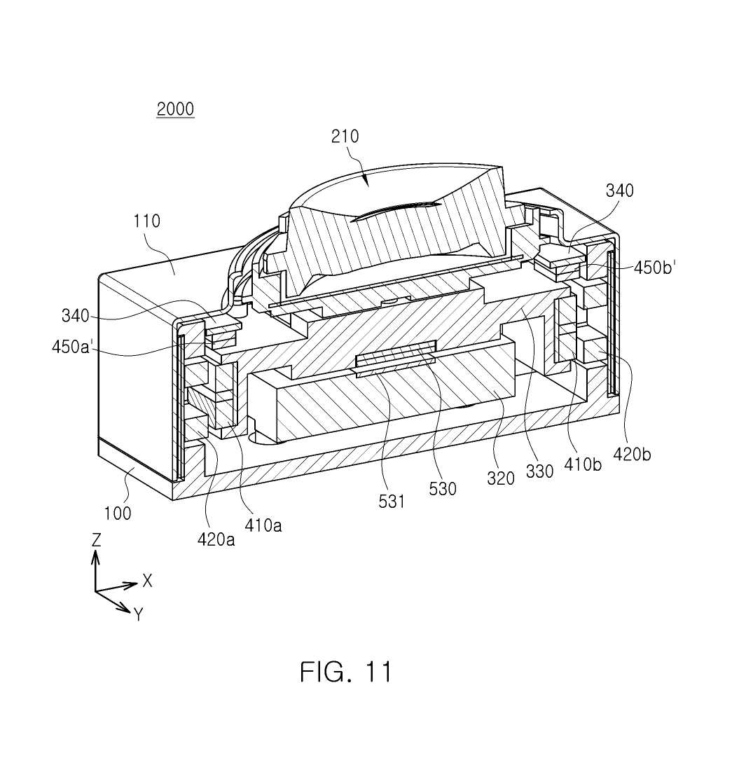

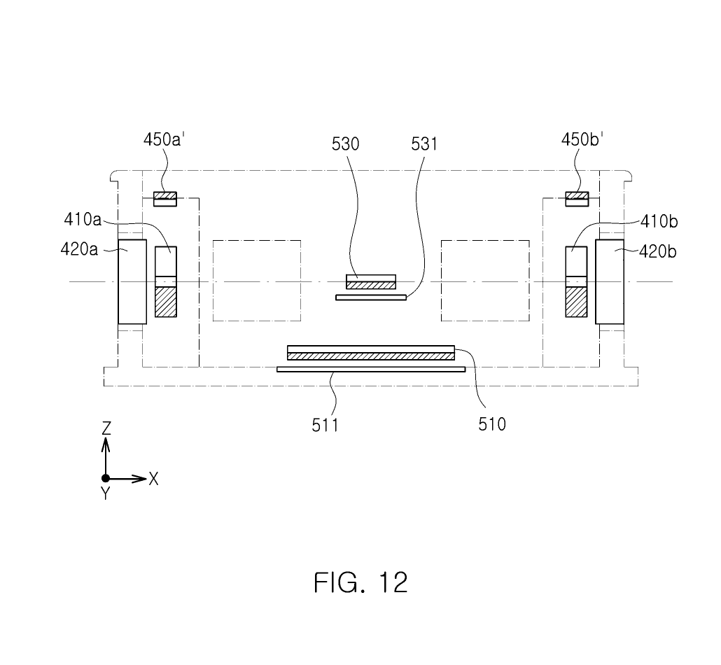

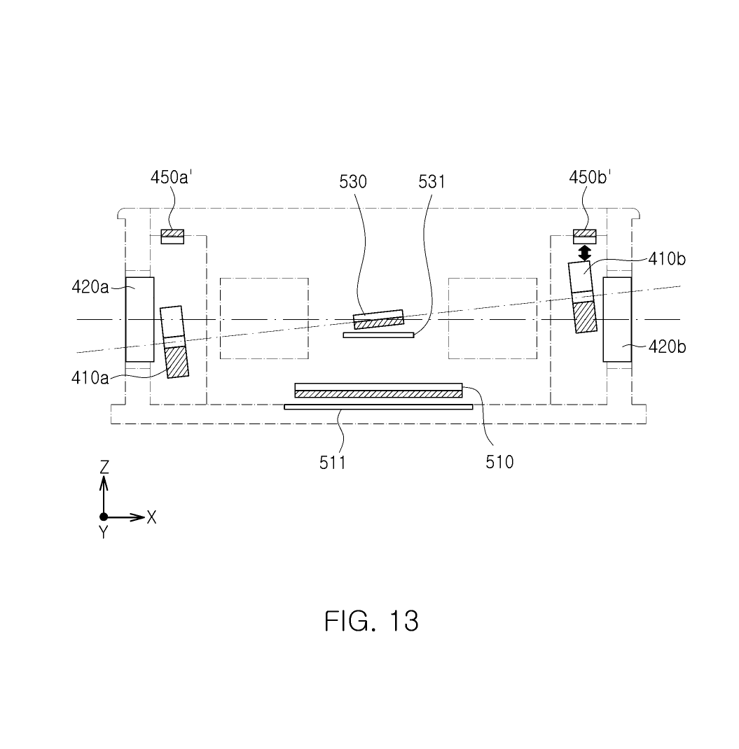

FIG. 11 is a cutaway perspective view of a camera module 2000 according to another embodiment of the present disclosure, which is a modification of FIG. 4. FIG. 12 is a diagram schematically illustrating a first driving unit, pulling magnets, pulling yokes, and a pushing magnet of the camera module of FIG. 11. FIG. 13 is a diagram schematically illustrating a state in which a reflective module of the camera module of FIG. 11 is tilted to one side compared to FIG. 12, and a repulsive force acts on the tilted reflective module.

Comparing FIG. 11 with FIG. 4, the camera module 2000 according to the present embodiment has a different arrangement of a pushing magnet 450'. Therefore, in describing the present embodiment, only the arrangement of the pushing magnet 450' that is different from the arrangement of the pushing magnet 450 of the camera module 1000 described above will be described, and the same descriptions as those given for the camera module 1000 described above may be applied to the other components.

Referring to FIG. 11, in the case of the camera module 2000 of the present embodiment, the pushing magnet 450' may be disposed on the first stopper 340. For example, the pushing magnet 450' may be disposed on a surface of the first stopper 340 facing the holder 330 in the third axis (the Z-axis) direction. However, the present disclosure is not limited thereto, and if the first stopper 340 is omitted, the pushing magnet 450' may be disposed on an inner surface of the case 110 facing the holder 330 in the third axis (the Z-axis) direction.

The housing 100 may include one side surface and another side surface connected to a lower surface of the housing 100 and facing each other in the first axial direction, and the pushing magnet 450' of the present embodiment may include a first pushing magnet 450a' adjacent to one side surface of the housing 100 and a second pushing magnet 450b' adjacent to the other side surface of the housing 100. A torque generated by the first pushing magnet 450a' on the holder 330 about the second axis (the Y-axis) and a torque generated by the second pushing magnet 450b' on the holder 330 about the second axis (the Y-axis) may be balanced with each other.

Referring to FIGS. 12 and 13, when a distance between the second magnet 410b and the second pushing magnet 450b' becomes relatively short due to rotation of the holder 330 about the second axis (the Y-axis) as illustrated in FIG. 13, a repulsive force between the second magnet 410b and the second pushing magnet 450b' may become stronger than a repulsive force between the first magnet 410a and the first pushing magnet 450a', so that the holder 330 may return to the original position even when power is not applied to the first driving unit 400 for rotating the reflective module 300. Here, the original position may refer to a state in which the holder 330 is not rotated, for example, a state in which the second pulling magnet 530 and the second pulling yoke 531 are parallel to each other as illustrated in FIG. 12.

Therefore, in the camera module 2000 of the present embodiment, when a driving force for rotating the holder 330 is not applied, a gap between the holder 330 and the one side surface of the housing 100 may be maintained constant by the pushing magnet 450'. In addition, a gap between the holder 330 and the other side surface of the housing 100 may also be maintained constant by the pushing magnet 450'.

The camera module 2000 according to an embodiment of the present disclosure may reduce power consumption for positioning the holder 330 by mechanically implementing a centering structure of the holder 330. Therefore, when the OIS function is not required (for example, when power is not applied to the driving unit 400 for rotating the reflective module 300), the position of the holder 330 may be adjusted without consuming power.

In the camera module according to an embodiment of the present disclosure, the reflective member may be maintained in a centered position even when power is not applied to the camera module, thereby improving the exterior of the camera module.

In the camera module according to an embodiment of the present disclosure, the pushing magnet for maintaining the reflective member in a centered position has a single pole, so that the sensitivity according to a polarization position may be reduced when the centered position is maintained.

While this disclosure includes specific embodiments, it will be apparent after an understanding of the disclosure of this application that various changes in form and detail may be made in these embodiments without departing from the spirit and scope of the claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing;
a reflective module comprising:
a guide member disposed in the housing and configured to be rotatable relative to the housing about a first axis extending in a first axial direction;
a holder disposed on the guide member and configured to be rotatable relative to the guide member about a second axis extending in a second axial direction; and
a reflective member disposed on the holder and configured to change a path of light incident in a third axial direction to a second axial direction; and
a first driving unit configured to rotate the guide member and the holder and comprising:
a first magnet disposed on opposite side surfaces of the holder in the first axial direction;
a first coil facing the first magnet in the first axial direction; and
a pushing magnet facing the first magnet in the third axial direction.

2. The camera module of claim 1, wherein surfaces of the first magnet and the pushing magnet facing each other have a same polarity.

3. The camera module of claim 1, wherein the pushing magnet is disposed in the housing.

4. The camera module of claim 1, further comprising:
a first pulling magnet disposed on the guide member or in the housing; and
a first pulling yoke facing the first pulling magnet in the third axial direction.

5. The camera module of claim 1, further comprising:
a second pulling magnet disposed between the first magnet disposed on opposite side surfaces of the holder in the first axial direction; and
a second pulling yoke facing the second pulling magnet in the third axial direction.

6. The camera module of claim 5, wherein the second pulling magnet is disposed on one of the holder and the guide member, and the second pulling yoke is disposed on another one of the holder and the guide member.

7. The camera module of claim 5, wherein an attractive force acts between the second pulling magnet and the second pulling yoke, and a repulsive force acts between the first magnet and the pushing magnet.

8. The camera module of claim 7, wherein the attractive force acting between the second pulling magnet and the second pulling yoke is greater than the repulsive force acting between the first magnet and the pushing magnet.

9. The camera module of claim 1, further comprising a first stopper coupled to the housing to cover at least a portion of the reflective module,
wherein the pushing magnet is disposed on the first stopper.

10. The camera module of claim 1, further comprising:
a plurality of first ball members disposed along the first axis; and
a plurality of second ball members disposed along the second axis.

11. The camera module of claim 10, wherein the plurality of first ball members are disposed between the housing and the guide member, and the plurality of second ball members are disposed between the guide member and the holder.

12. A camera module comprising:
a housing;
a guide member configured to rotate relative to the housing about a first axis extending in a first axial direction;
a holder configured to rotate relative to the guide member about a second axis perpendicular to the first axis and extending in a second axial direction;
a first magnet disposed on opposite side surfaces of the holder in the first axial direction; and
a pushing magnet disposed to face the first magnet in a third axial direction perpendicular to each of the first axis and the second axis and configured to generate a repulsive force,
wherein the pushing magnet comprises a plurality of magnets symmetrically disposed with respect to the second axis.

13. The camera module of claim 12, wherein the housing comprises a lower surface, and one side surface and another side surface connected to the lower surface and facing each other in the first axial direction, and
the pushing magnet is disposed on the lower surface of the housing.

14. The camera module of claim 13, wherein the pushing magnet comprises a first pushing magnet adjacent to the one side surface of the housing and a second pushing magnet adjacent to the other side surface of the housing, and
a torque generated by the first pushing magnet on the holder and a torque generated by the second pushing magnet on the holder are balanced with respect to the second axis.

15. The camera module of claim 13, wherein, in a state in which no driving force is applied to rotate the holder, a gap between the holder and the one surface of the housing and a gap between the holder and the other surface of the housing are each constant.
